(19) United States
(12) Patent Application Publication
(10) Pub. No.: US 2013/0016003 A1
(43) Pub. Date: Jan. 17, 2013

(54) BEAM FORMING DEVICE AND METHOD USING FREQUENCY-DEPENDENT CALIBRATION

(71) Applicants: Richard STIRLING-GALLACHER, Dallas, TX (US); Miquel TESTAR, Stuttgart (DE); Furkan DAYI, Stuttgart (DE); Ralf BOEHNKE, Esslingen (DE); Marcel BLECH, Herrenberg (DE); Qi WANG, Stuttgart (DE)

(72) Inventors: Richard STIRLING-GALLACHER, Dallas, TX (US); Miquel TESTAR, Stuttgart (DE); Furkan DAYI, Stuttgart (DE); Ralf BOEHNKE, Esslingen (DE); Marcel BLECH, Herrenberg (DE); Qi WANG, Stuttgart (DE)

(73) Assignee: Sony Corporation, Tokyo (JP)

(21) Appl. No.: 13/546,625

(22) Filed: Jul. 11, 2012

(30) Foreign Application Priority Data
Jul. 11, 2011 (EP) 11 173 490.1

(51) Int. Cl. H01Q 3/26; G01S 7/40

(52) U.S. Cl. 342/174; 342/372

(57) ABSTRACT

A beam forming device that enables the use for wideband digital beam forming and provide a high accuracy a beam forming device comprises a transmitter arrangement and a receiver arrangement, wherein the total number of transmit antennas and receive antennas is at least three. A beam forming unit performs beam forming to obtain beam formed output signals from said receive signals by use of corrected beam forming weights. A correction unit corrects preliminary beam forming weights in amplitude and/or phase by use of frequency-dependent final calibration coefficients representing the different amplitude and/or phase responses of the different channels between said at least one transmit antenna and said at least one receive antenna at two or more separate frequencies covered by the radiation transmitted towards the scene.

### CROSSREFERENCES TO RELATED APPLICATIONS

The present application claims the benefit of the earlier filing date of EP 11173490.1 filed in the European Patent Office on Jul. 11, 2011, the entire content of which application is incorporated herein by reference.

### BACKGROUND

1. Field of the Disclosure

The present disclosure relates to a beam forming unit and a beam forming method. Further, the present disclosure relates to an active imaging device and a corresponding method for imaging a scene. Still further, the present disclosure relates to a computer readable non-transitory medium storing a computer program.

2. Description of Related Art

Active imaging systems are becoming more and more popular at ultra-sonic, microwave, millimetre and terahertz frequencies for a number of applications including medical and security applications.

The arrangement of transmitter (herein also called “transmit unit”) and receiver (herein also called “receive unit”) in an active imaging system may take on many different forms. In an embodiment relevant for the present disclosure multiple transmitters and receivers work together to form a MIMO radar (or MIMO active imaging system.) There are predominately two different types of MIMO radars. The first type is called statistical MIMO, in which the antennas (generally the “transmit antennas” and the “receive antennas”) are placed far apart from each other to provide different views of the object (generally the “scene”). The second type of MIMO is called beam forming (or co-located) MIMO in which the antennas are placed close to each and act together to form a “virtual” beam forming array.

MIMO beam forming in one dimension is typically combined with other techniques (i.e. synthetic aperture radar) to form a 2D image. Alternatively, MIMO beam forming can be performed in two dimensions to form a 2D image. To yield a full 3D image of an object (or a 2D image with additional distance/depth information), such arrangements typically transmit a wideband continuous waveform (i.e. frequency modulated continuous wave (FMCW)) or a wideband pulse to provide ranging (distance) information.

For any beam forming arrangement, it is essential that the system is calibrated. Calibration is needed since the different channels, i.e. different transmitter to receiver combinations, may have different phase and amplitude responses, and these different responses need to be known so that the correct complex weights for beam forming can be calculated. Methods for calibrating beam forming systems for active imaging (or radar applications) are generally known.

Winfried Mayer, “Abbildender Radarsensor mit senderseitig geschalteter Gruppenantenne” (in German), Ph. D. Dissertation, University of Ulm, 15 Feb. 2009, Cuvillier Publisher, ISBN 978-3-86727-565 1 and W. Mayer et al, “A Compact 24 GHz Sensor for Beam Forming and Imaging”, International Conference on Control, Automation, Robotics and Vision (ICARCV 2006), Singapore, 5-8 Dec. 2006 describe a FMCW radar system which uses two receivers and a number of different transmitting antennas, placed at different positions. For each sent chirp pulse, a different transmitting antenna is used for transmission. From a receiver point of view, therefore, the transmitter is seen to be moving in a stop/start fashion. To create beams, SAR algorithms (which are normally used for moving radars) are used to create a large antenna aperture and to synthesise different beams. Since SAR algorithms do not require each receiver to produce phase information, only one Analogue to Digital converter (ADC) is used for each receiver.

In the article of W. Mayer et al two different calibration methods are described for this system. The first method measures the time delay and amplitude response of each of the different channels (different transmitter/receiver combinations) in the frequency domain (after the FFT). The difference in the time delays between different channels corresponds to a phase offset between the channels. The second method measures the beat signal in the time domain (before the FFT) as the transmitter is transmitting the FMCW pulse. In this way, the delay time and amplitude response for each channel can be measured at different transmitted frequencies.

M. L. Lees, “Digital Beamforming Calibration for FMCW radar”, IEEE Transactions on Aerospace and Electronic Systems (AES), March 1989, pp. 281-284 describes a large (3 km aperture) high frequency radar narrow band system (50 KHz) bandwidth in which each of the different receivers first performs an FFT on the received beat signal. Then digital beam forming is performed across the receivers for each FFT bin. The article describes the effect of phase offsets and frequency offsets (due to the large path difference between antennas) and proposes how these effects can be mitigated once the phase offset and frequency offset are known.

L. Li et al, “Software defined Calibration for FMCW Phased-Array Radar”, IEEE Radar Conference 2010, 10-14 May 2010, pp. 877-881 describes a FMCW phased array radar system in which the calibration is performed in two stages. The first stage called temporal calibration focuses on measuring and calibrating the non-linearities of the FMCW waveform (caused by the use of an inexpensive non-linear VCO). Once the FMCW waveform has been non-linearly compensated in the second stage of calibration the spatial calibration is performed. In this stage a cable is successively connected between the different channels (different transmitter and receiver combination) and the different channel delays, frequency shifts and phase responses are measured and calibrated out.

A. Schiessl et al, “W-Band Imaging of Explosive Substances”, Proceedings of the 6th European Radar Conference, 30 Sep.-2 Oct. 2009, pp. 617-620 describes a system which uses one transmitter and one receiver. The single transmitter and single receiver both move to 128 different positions and a SAR algorithm is used to create a large antenna aperture to synthesize different beams. Since this system uses only one transmitter (with transmitter antenna) and receiver (with receiver antenna), all of the different channels (128×128) have the same response and therefore the difference between the receivers does not need to be calibrated. A simple single transceiver calibration (standard 2-port calibration) is performed when the antennas are in the center position to normalise the receiver amplitude and phase.

The “background” description provided herein is for the purpose of generally presenting the context of the disclosure. Work of the presently named inventor(s), to the extent it is described in this background section, as well as aspects of the description which may not otherwise qualify as prior art at the time of filing, are neither expressly or impliedly admitted as prior art against the present invention.

### SUMMARY

It is an object of the present disclosure to provide a beam forming device and a corresponding method including wideband digital beam forming, which device and method can preferably be used for beam forming (and e.g. active imaging) in the near field (but generally also in the far field) and provide a high accuracy. It is a further object of the present disclosure to provide a corresponding active imaging unit and a corresponding active imaging method as well as a corresponding computer program for implementing said beam forming method in software and a computer readable non-transitory medium storing such a computer program.

According to an aspect of the present disclosure there is provided a beam forming device comprising:

a transmitter arrangement comprising at least one transmit antenna that transmits radiation towards a scene,

a receiver arrangement comprising at least one receive antenna that receives radiation from said scene and at least one receive unit that generates receive signals from said received radiation, wherein the total number of transmit antennas and receive antennas is at least three,

a beam forming unit that performs beam forming to obtain beam formed output signals from said receive signals by use of corrected beam forming weights, and
a correction unit that corrects preliminary beam forming weights in amplitude and/or phase by use of frequency-dependent final calibration coefficients representing the different amplitude and/or phase responses of the different channels between said at least one transmit antenna and said at least one receive antenna at two or more separate frequencies covered by the radiation transmitted towards the scene.

According to a further aspect of the present disclosure there is provided an active imaging device for imaging a scene comprising a beam forming device and a processing unit for processing said beam formed output signals.

According to still further aspects corresponding methods and a computer readable non-transitory medium having instructions stored thereon which, when carried out on a computer, cause the computer to perform the steps of the beam forming method according to the present disclosure are provided.

Preferred embodiments of the disclosure are defined in the dependent claims. It shall be understood that the claimed devices, the claimed methods and the claimed computer readable medium have similar and/or identical preferred embodiments as the claimed beam forming device and as defined in the dependent claims.

As mentioned above calibration is needed in beam forming devices and methods since the different channels may have different phase and amplitude responses, which need to be known so that the correct complex weights for beam forming can be calculated. Additionally, it has been found that for wideband systems the phase and amplitude responses of the different channels may be different at different frequencies. Furthermore, the individual phases and amplitudes of the different channels may change with time (due to component ageing, vibration or changes in temperature, pressure and/or humidity). When the proposed beam forming device is used in active imaging systems, the waveform generator (or chirp generator) may also have a variation of output power with frequency.

Based on this recognition the present disclosure is based on the idea to provide an efficient calibration scheme and, particularly, to make use of frequency-dependent calibration coefficients for adapting the weights used the beam forming. For at least two frequencies, preferably a plurality of frequencies, within the wide frequency band covered by the radiation transmitted towards the scene individual optimum weights are thus calculated and used for beam forming to ensure that the formed beam has the desired shape and direction. In other words, it is taken into account according to the present disclosure that the phase and amplitude responses of the different channels may be different at different frequencies. This finally leads to an increased accuracy of the imaging even if the distance of the scene changes continuously or from time to time.

Preferably, a full wideband calibration scheme that calibrates the whole receiver and transmitter chain for each channel is provided in an embodiment. Further, in another embodiment, an additional internal calibration scheme is provided which can be performed at regular intervals to track any phase or amplitude changes of the active components in each channel with may occur with time.

Although the calibration techniques described in the above mentioned article of W. Mayer et al can be performed at different frequencies, they have important differences to the present disclosure. According to the present disclosure digital beam forming is performed with complex weighting vectors and the SAR algorithm is not used. Therefore each receiver has to produce phase information. According to an embodiment of the present disclosure it is proposed to measure the phase and/or amplitude (preferably at least phase) for some (preferably each) channels for some (preferably each) received sample of the beat frequency (before the FFT). Each receive sample of the beat frequency corresponds to a different instantaneous frequency from the sent FMCW signal. Furthermore, an additional internal calibration loop is preferably used which encapsulates the active components to track the phase and amplitude changes of the different channels with time.

Compared to the beam forming calibration described in the above mentioned article of M. L. Lees the present disclosure proposes a calibration method to measure the phase and amplitude response for each channel separately and proposes to do this at a number of different frequencies.

Compared to the calibration described in the above mentioned article of L. Li et al the present disclosure does not propose to measure and calibrate out the non-linearities of the FMCW waveform in a separate step. Additionally when the present disclosure perform a full calibration, a reference object is used, which has a known characteristic and is placed at a known distance from the transmitters and receivers. The present disclosure provides the advantage that any differences in the antennas used for the different channels are also taken into account. Additionally, the present disclosure proposes that the calibration is done at multiple frequencies. Furthermore, the present disclosure proposes that preferably an additional internal loop is used to track any changes in the response of the active components with time.

Compared to the imaging method described in the above mentioned articles of the present disclosure does not propose to use the SAR algorithm, but to use digital beam forming. Additionally, the present disclosure preferably uses two or more receivers and therefore the different channels are calibrated for the beam form algorithm to work correctly.

It shall be noted that the presented beam forming device and method may also be used for an iterative imaging approach, e.g. for (conventional) 3D backprojection processing. In this case an imaging unit that performs focusing in at least two dimensions may be provided. The imaging unit calculates the elements in the imaging space in an iterative manner.

Generally holds that the preliminary weights that are corrected as proposed herein are preferably precalculated, but may alternatively be calculated iteratively (i.e. on the fly).

It is to be understood that both the foregoing general description of the invention and the following detailed description are exemplary, but are not restrictive, of the invention.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 shows a general layout of an active imaging device including a beam forming device according to the present disclosure,

FIG. 2 shows a schematic diagram of a first embodiment of a beam forming device according to the present disclosure,

FIG. 3 shows a schematic diagram of a second embodiment of a beam forming device according to the present disclosure,

FIG. 4 shows a schematic diagram of a third embodiment of a beam forming device according to the present disclosure,

FIG. 5 shows a schematic diagram of a fourth embodiment of a beam forming device according to the present disclosure,

FIG. 6 shows diagrams illustrating beat frequency time samples for illustrating the present disclosure,

FIG. 7 shows a general flow chart of an active imaging method according to the present disclosure,

FIG. 8 shows a flow chart of an embodiment of a beam forming method according to the present disclosure,

FIG. 9 shows a typical (frequency modulated continuous wave) FMCW radar system and typical frequency against time waveforms for a FMCW radar system,

FIG. 10 shows a typical frequency against time waveform for a FMCW radar system,

FIG. 11 shows an example measurement arrangement for a channel,

FIG. 12 shows a first embodiment of a calibration calculation unit,

FIG. 13 shows a second embodiment of a calibration calculation unit,

FIG. 14 shows an embodiment of a calibration calculation sub-unit for addition to the second embodiment of a calibration calculation unit,

FIG. 15 shows an embodiment of a measurement unit as used in the calibration units.

### DESCRIPTION OF THE EMBODIMENTS

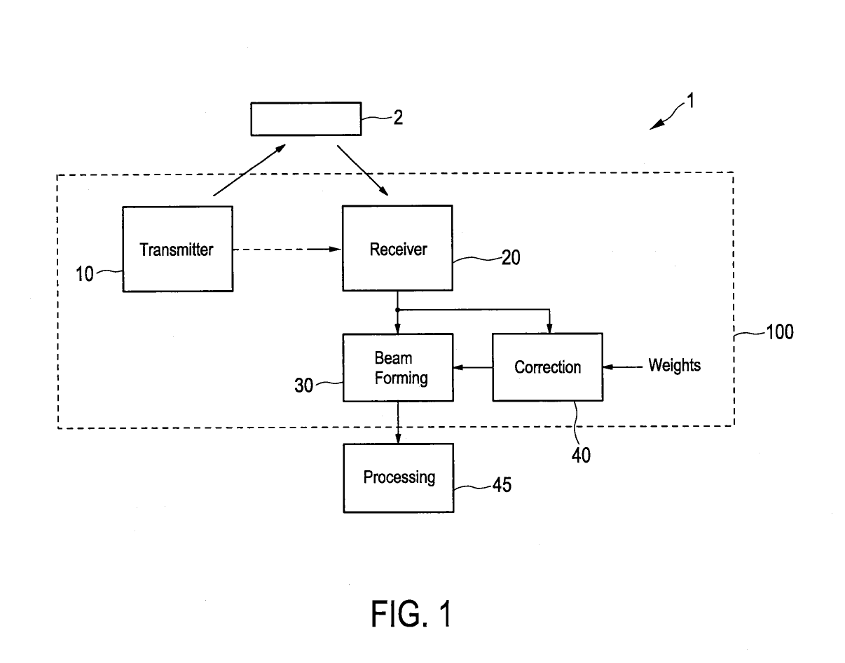

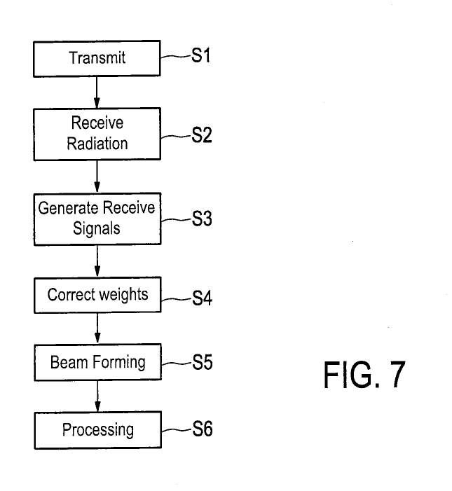

Referring now to the drawings, wherein like reference numerals designate identical or corresponding parts throughout the several views, FIG. 1 shows a general layout of an active imaging device 1 for imaging a scene 2 including a beam forming device 100 according to the present disclosure. A flow chart of a corresponding active imaging method is shown in FIG. 7. The device 1 comprises a transmitter arrangement 10 comprising at least one transmit antenna that transmits radiation (step S1 in FIG. 7) towards said scene 2 (said radiation being also referred to as transmit signals) and a receiver arrangement 20 comprising at least one receive antenna that receives (step S2) radiation from said scene 2 and at least one receive unit that generates (step S3) receive signals from said received radiation. The total number of transmit antennas and receive antennas is at least three, i.e. there are at least two transmit antennas if there is only a single receive antenna, or there are at least two receive antennas if there is only a single transmit antenna. Preferably, there are at least two or even a plurality of transmit antennas and receive antennas.

A beam forming unit 30 is provided that performs beam forming (step S5) to obtain beam formed output signals from said receive signals by use of corrected beam forming weights. Further, a correction unit 40 is provided that corrects (step S4) preliminary beam forming weights in amplitude and/or phase by use of frequency-dependent final calibration coefficients representing the different amplitude and/or phase responses of the different channels between said at least one transmit antenna and said at least one receive antenna at two or more separate frequencies covered by the radiation used for illumination of the scene. These corrected beam forming weights are then used by the beam forming unit 30 for beam forming in step S5. Further, a processing unit 45 is provided for processing (step S6) the beam formed output signals of the beam forming unit 30, e.g. to reconstruct an image of the scene 2. However, the beam formed output signals could also be used for other purposes and in other devices than active imaging devices, e.g. for object detection, distance determination, etc.

The present disclosure is directed to calibrating wideband beam forming, in particular using wideband signals, which are formed by a signal (or pulse) which is changing its frequency with time. An example of such a system is the commonly used frequency modulated continuous wave (FMCW) active imaging approach which will be explained in more detail below. Generally, the present disclosure can be used in an active imaging system, but may also be used in other applications. Possible example applications could be FMCW radar systems, frequency hopped communications systems or chirp based communications systems, generally for the transmission of any kinds of data. Further, the present disclosure can also be applied to systems where multiple sweeping or time varying signals are sent at the same time, while these signals can be separated in the receiver.

The arrangement of transmitters and receivers in an active imaging device may take on many different forms, but in the following devices will mainly be considered as an example, in which multiple receive antennas and one or more receive unit (for processing the signals received by the receive antennas) are used to perform beam forming. Such an arrangement may use one transmit antenna or may use multiple transmit antennas (and one or more transmit units for providing the transmit signals to the transmit antennas) in combination with the multiple receive antennas to perform beam forming (so called ‘MIMO beam forming’).

For any beam forming arrangement, it is essential that the system is calibrated. Calibration is needed since the different channels (different transmitter to receiver combinations) may have different phase and amplitude responses, and these different responses need to be known so that the correct complex weights for beam forming can be calculated. Additionally, for wideband systems the phase and amplitude responses of the different channels may be different at different frequencies and these differences need to be considered. Furthermore, the individual phase and amplitude of the different channels may change with time (i.e. due to component ageing, vibration or changes in temperature, pressure and/or humidity).

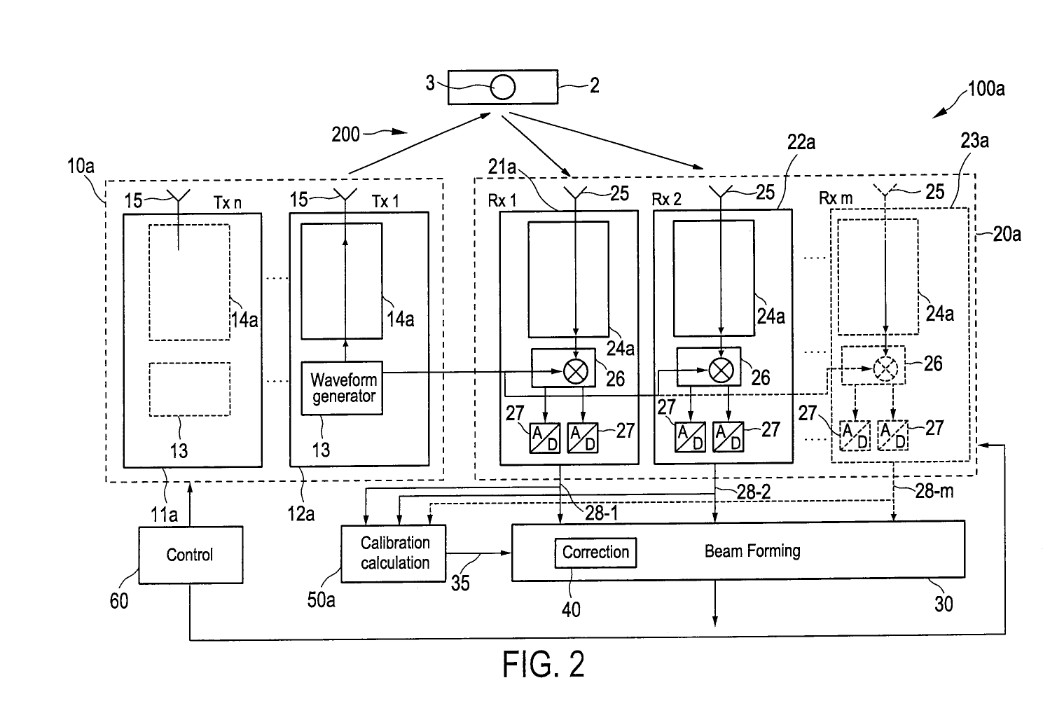

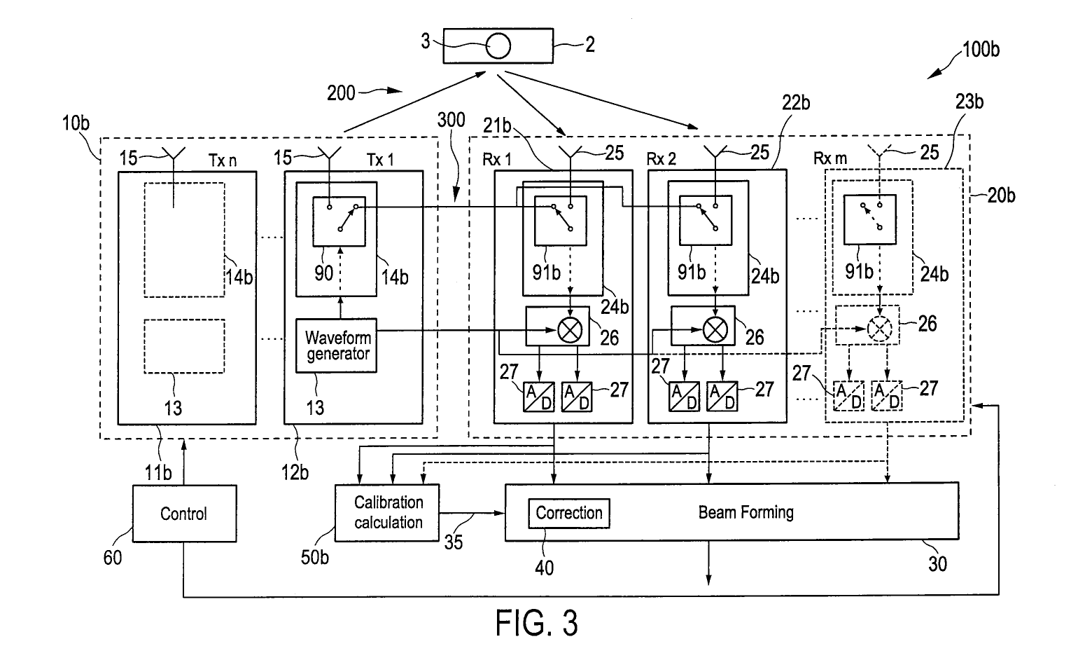

Various embodiments of an FMCW beam forming device 100a-100d are shown in FIGS. 2 to 5. Referring to the embodiment 100a shown in FIG. 2 the transmitter 10a (i.e. the transmitter arrangement) comprises two transmit elements 11a, 12a (also called transmit units). Each transmit unit 11a, 12a comprises a waveform generator 13 which produces a repetitive waveform which changes its frequency with time, typically a chirp pulse. The generated waveform is then passed to each receive element 21a, 22a, 23a (also called receive element) and also to the internal RF units 14a of the transmit units 11a, 12a. The internal RF units 14a typically amplify this waveform so that it has the correct power level for transmission. For the proposed calibration scheme, the resulting signal can be switched to either the transmitter antenna 15 for transmission to an external loop 200 for transmitting radiation towards the scene 2 or to an internal loop 300 connected to the receiver front ends 24a (by bypassing the transmitter and receiver antennas 15, 25). This internal loop 300 forms a second calibration loop which will be described below with reference to FIG. 3.

Generally, each transmitter antenna 15 is coupled to its own transmit element 11, 12. In other embodiments, however, two or more transmitter antennas 15 can be coupled/switched to a single (common) transmit element. In a similar way, each receive antenna 25 is generally coupled to its own receive unit 21, 22, 23. In other embodiments, however, two or more receive antennas 25 can be coupled/switched to a single (common) receive unit.

When the signal is transmitted via the transmitter antenna 15 through the external loop 200, a reference object 3 (of known size, distance and reflection properties) is placed at a fixed distance from the transmitter and receiver antennas 15, 25. The reflected signal is then received by the different receive units 21a, 22a, 23a. This external loop 200 forms the first calibration loop. Each receive unit 21a, 22a, 23aAfter several stages of RF amplification (and/or down conversion) stages in the receiver front end 24a, the resulting signal is passed to a mixer 26 (preferably an I/Q mixer or a mixer and an I/Q generation circuit, such as Hilbert filter transform) which mixes the signal with the waveform received directly from the transmit units 11a, 12a to produce a complex ‘beat frequency’ waveform whose frequency corresponds to the distance of the object (e.g. by applying the usual FMCW receiver principle, as explained below).

The complex output of the mixer 26 is then generally filtered and passed to two A/D (analogue to digital) converters 27 which produce digital outputs, preferably the I and Q outputs (i.e. an in-phase output and a quadrature output). These outputs are passed to the beam forming unit 30 which amplifies and phase shifts the different received signals, so that different beam positions can be formed. For the proposed calibration approach these A/D outputs are also passed to a calibration calculation unit in this embodiment, which computes the calibration coefficients of each channel (transmitter/receiver combination) and feeds the results to the beam forming unit 30, in particular the correction unit 40 so that the complex beam forming weights can be adjusted (in phase and/or amplitude; preferably at least in phase) and correct beaming can be achieved.

Thereafter, these corrected beam forming weights are used for beam forming during actual use of the beam forming device 100a. The beam formed output signals generated from actually measured receive signals can then be further processed in a processing unit 45 (see FIG. 1), e.g. an image of the scene 2 can be formed from said beam formed output signals.

The beam forming device may also be used for an iterative imaging technique, e.g. 3D backprojection processing. In this case an imaging unit that performs focusing in at least two dimensions may be provided for calculating the elements in the image space in an iterative manner. In other words, an imaging unit may be provided that performs digital focusing to obtain focused output signals from said receive signals by use of corrected focusing weights that are obtained in an iterative process.

It is important to note that for standard beam forming to work correctly, it is preferred that the phase differences between the channels are corrected. Any amplitude differences between the channels will generally not affect the beam forming angle (or pointing direction) with the highest response. If the different channels change their gain with time, the overall gain of the beam forming angle with the highest response will change, which will affect the final received signal power (or final image intensity). However, by adjusting the amplitude gains of the different channels, it is possible to change the levels of the side lobe (unwanted response of the beam forming). An example of this is Dolph-Chebyshev weighting windows which optimally set the amplitude gain of the separate channels so that all side lobe levels are below a certain value.

For the sake of clarity the proposed calibration method will be explained in the following using phases. If it is required that the amplitude gain calibration is also needed the same method can be used in parallel for amplitude gain calibration, but any subtraction (using phases) needs to be replaced by an amplitude gain division and any addition (using phases) needs to be replaced by an amplitude gain multiplication.

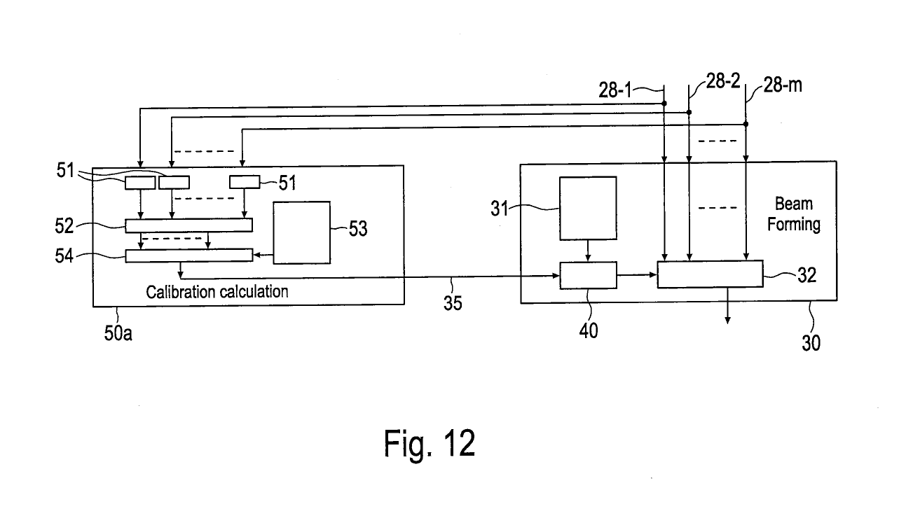

First, the calibration using only the external calibration loop 200 shall be explained in more detail with reference to FIG. 2 and FIG. 12 showing an embodiment of the calibration calculation unit 50a and the beam forming unit 30. This method (which is the simplest method) can be used on its own, if it is envisaged that the different channels will not change their phase characteristics (and optionally amplitude characteristics) with time or if the use of the beam forming device allows a reference object to be used at regular intervals at a known fixed distance from the transmitter and receiver antennas. The method works as follows.

A reference object 3 (of known size, distance, position and reflection properties) is placed in the field of view of the beam forming device 100a. Since this reference object 3 has known properties and is at a known location, the path distance for each channel (transmitter/receiver combination) can be computed.

For several (preferably each) frequencies of operation, therefore, the expected phase differences (due to path differences) between the different channels and one reference channel (normally channel 1) are computed (e.g. by simulation, estimation or numerical calculation) and the results are stored in a storage unit 53 in the calibration calculation unit 50a. These expected phase difference is mathematically represented as

E_{Ext loop,x1}(k) (1)

which represents the expected phase difference for this external loop between channel x and channel 1, for frequency step k.

Each transmit unit 11a, 12a then sends one chirp pulse (or multiple chirp pulses) in turn to the reference object 3 and each receive unit 21a, 22a, 23a passes the received beat frequency complex samples to the calibration calculation unit 50a.

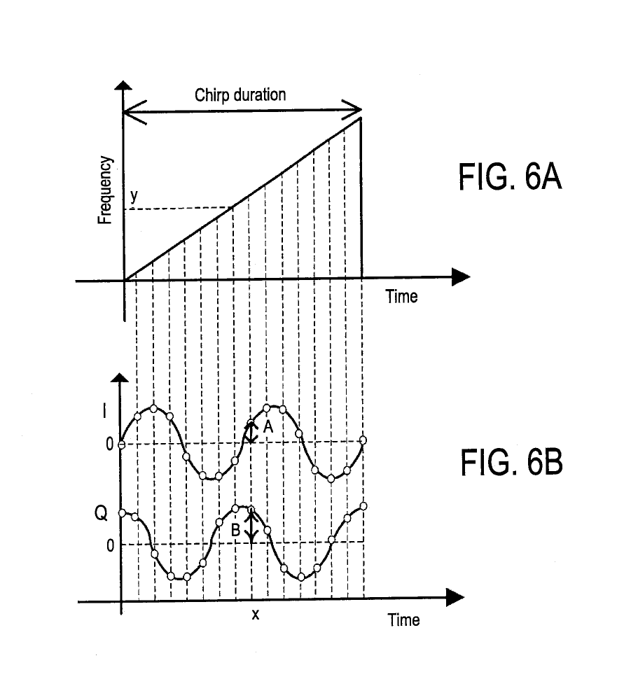

Each sample of the different received beat frequency samples corresponds to a different instantaneous frequency of the transmitted waveform which is illustrated in FIG. 6. Here, FIG. 6A shows a frequency ramp of a chirp pulse, and FIG. 6B shows beat frequency time samples. For time sample x (which corresponds to sample at frequency y, the phase corresponds to tan⁻¹(A/B) and the amplitude corresponds to sqrt(A²+B²).

The calibration calculation unit 50a (as shown in FIG. 12) then measures in measurement units 51 the phase (and optionally amplitude) using the I/Q samples 28-1, 28-2, 28-m obtained from the different receive units 21a, 22a, 23a for several (preferably each) samples, which corresponds to several (preferably each) frequency step for each channel. This measurement may be done over multiple chirp durations (with averaging) to reduce the effects of noise. Additionally, extra filtering may also be used for this step to reduce the noise floor.

The differences between the channels in terms of measured phase at each frequency step are then calculated in a calculation unit 52. This can mathematically be represented as

θₓ(k)−θ₁(k) (2)

which represents the measured phase difference between channel x and channel 1, for frequency step k (which corresponds to time sample k).

From these calculated differences between the channels the expected differences stored in a storage unit 53 between the channels for each frequency step k are then subtracted in subtraction unit 54. The results of this subtraction for each frequency step and for each channel, optionally after low pass filtering to reduce the noise, are the complex calibration coefficients 35 which are fed to the correction unit 40, which may be internal or external to the beam forming unit 30 and which corrects the complex weight for each required beam (here, the complex weight for each required beam is either pre-stored (in storage unit) or online (on the fly) calculated). This can mathematically be represented as finalₓ₁(k)

finalₓ₁(k)=(θₓ(k)−θ₁(k))−E_{Ext loop,x1}(k) (3)

which represents the final (external) complex calibration coefficient 35 (here as phase shift) for channel x (reference to channel 1) for frequency step k (=time step k). In this way, the beam forming performed in the final beam forming unit 32 can take into account the different channel phase responses at each frequency step.

A control unit 60 is generally provided that controls said transmitter arrangement 10 to transmit radiation towards said scene 2 with radiation which is frequency time varying and covers at least two separate sampled instantaneous frequencies, corresponding to at least two successive time samples of the received complex beat frequency signal (I/Q) as shown in FIGS. 6A and 6B. It should be noted in this context that FIG. 6A shows an example in which 16 successive complex time samples correspond to 16 different instantaneous frequencies of the frequency time varying radiation. Radiation is transmitted towards said scene while a reference object 3 is placed in the scene at a known distance from the at least one transmit unit and the at least one receive unit, and that controls said receiver arrangement 20 to receive radiation at said at least two separate frequencies from said reference object 3, to generate receive signals and to provide said receive signals to said calibration calculation unit 50a.

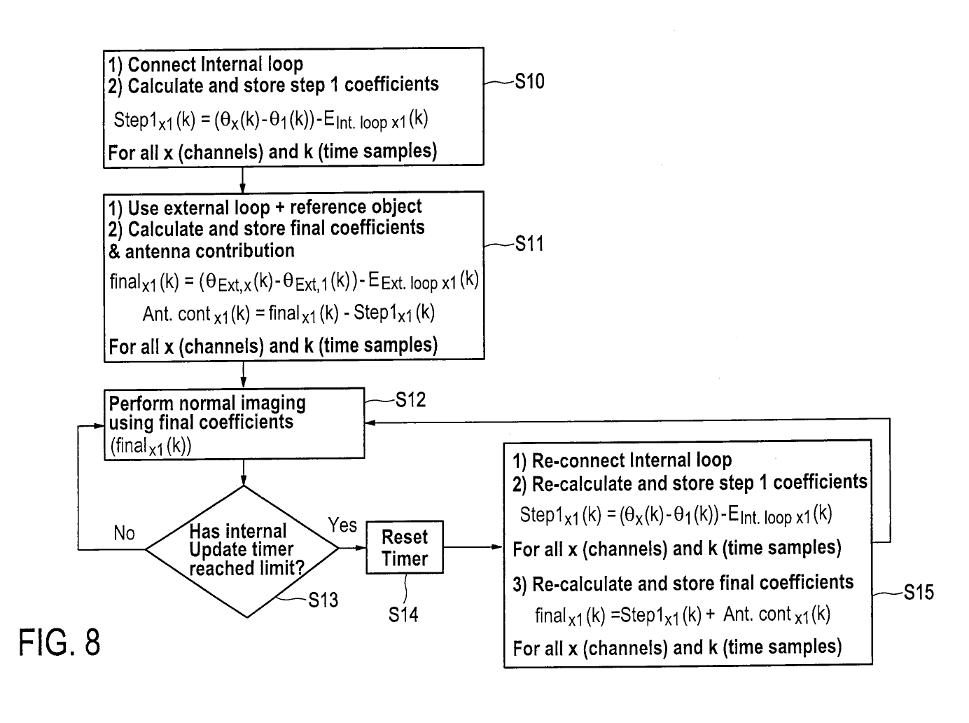

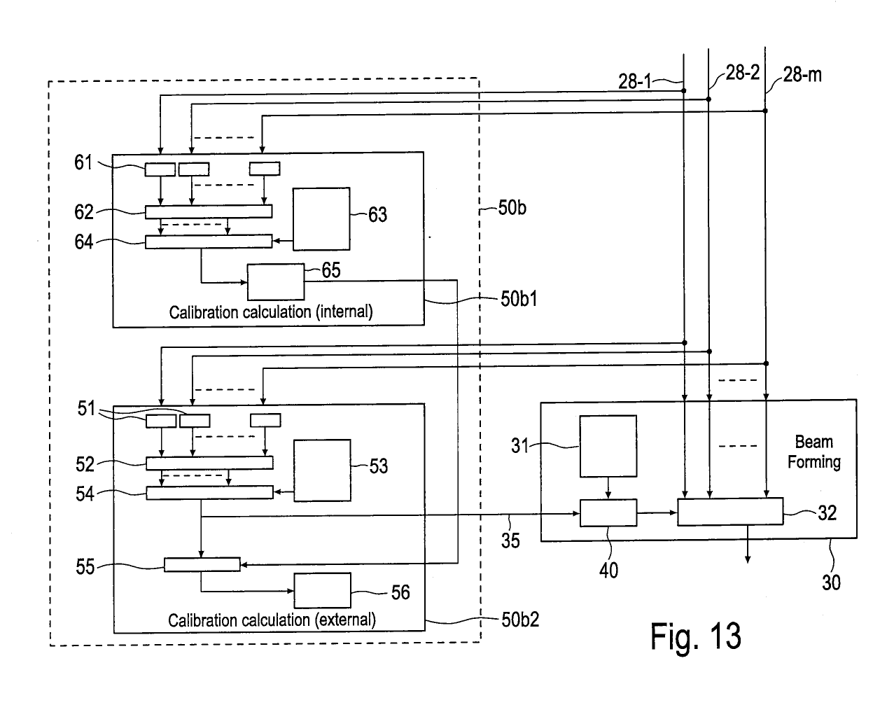

Next, the calibration using the external calibration loop 200 and the internal calibration loop 300 shall be explained in more detail with reference to FIG. 3 showing a second embodiment of a beam forming device 100b according to the present disclosure and FIG. 13 showing another embodiment of the calibration calculation unit 50b and the beam forming unit 30. This device 100b and the corresponding method work in a similar way to the first embodiment, but this device 100b includes two calibration loops 200 and 300 and multiple steps. A complete flow chart of the method is shown in FIG. 8.

This method is particularly applicable to situations where it is anticipated that the active components of the different channels will change the phase characteristic (and optionally amplitude characteristic) with time (i.e. due to component ageing, vibration or changes in temperature, pressure and/or humidity).

The first step (step S10 in FIG. 8) of this calibration method is an internal calibration making use of the first calculation sub-unit 50b1, which uses the internal calibration loop 300 to connect the RF signal (just before the transmitting antenna 15) of each transmit unit 11b, 12b one at time to all of the receiver elements 21b, 22b, 23b by bypassing the receiver antennas 25. To switch between external calibration loop 200 and internal calibration loop appropriate selection elements 90, 91b are provided. These selection elements comprise particularly a transmit switching element 90 included in each transmit unit 11b, 12b, in particular included in each RF unit 14b for switching between the transmission of radiation through said external calibration loop 200 and the transmission of radiation through said internal calibration loop 300. Further, the selection elements comprise a receive switching element 91b included in each receive unit 21b, 22b, 23b for switching between the reception of radiation from the scene 2 (more particularly the reference element 3) trough said external calibration loop 200 in response to the transmission of radiation transmitted by a transmit unit 11b, 12b through said external calibration loop 200 and the reception of radiation through said internal calibration loop 300 transmitted by an transmit unit 11b, 12b through said internal calibration loop 300. The switch positions shown in FIG. 3 are correctly set for step S10 of the method shown in FIG. 8.

In advance the characteristics (phase and amplitude) of the internal calibration loop 300 for each channel are measured (off-line) and the differences (for phase and amplitude) between the channels for several (preferably each) frequency steps are pre-stored in a storage unit 63 in the calibration calculation sub-unit 50b1. This shall be called the ‘expected internal loop differences’ which can be mathematically represented as

E_{Int loop,x1}(k) (4)

which represents the expected phase difference for the internal loop between channel x and channel 1, for frequency step k.

Each transmit unit 11b, 12b then sends one (or multiple chirp pulses) through the internal loop 300 and each receiver element 21b, 22b, 23b passes the received beat frequency samples to the calibration calculation unit 50b. The calibration calculation sub-unit 50b1 measures the phase and (optionally amplitude) in measurement units 61 using the I/Q samples for several (preferably each) samples of each received stream 28-1, 28-2, 28-m (which corresponds to several, preferably each, frequency steps) and for each channel. This measurement may be done over multiple chirp durations (with averaging) to reduce the effects of noise. Additionally, extra filtering may also be used for this step, to reduce the noise floor.

The differences between the channels in terms of measured phase at each frequency step are then calculated in a calculation unit 62. This can mathematically be represented as

θ(k)−θ₁(k) (5)

which represents the measured phase difference between channel x and channel 1 for frequency step k (which corresponds to time sample k).

These calculated differences between the channels are then passed to a subtraction unit 64 which subtracts the pre-stored ‘expected internal loop differences’ (stored in storage unit 63) between the channels for each frequency step. The results of this subtraction for each frequency step and for each channel are then the complex (internal) step 1 calibration coefficients which are then stored in another storage unit 65, e.g. within the first calibration calculation sub-unit 50b1 or the second calibration calculation sub-unit 50b2. The step 1 calibration coefficient can mathematically be represented as Stepₓ₁(k)

Step1ₓ₁(k)=(θₓ(k)−θ₁(k))−E_{Int loop,x1}(k) (6)

which represents the (external) Step 1 calibration coefficient (here as phase shift) for channel x (reference to channel 1) for frequency step k (=time step k). These complex coefficients represent the differences between the channels without the transmitter and receiver antennas 15, 25 (and their respective feeding networks) at that given period of time.

The second step (S11 in FIG. 8) of this embodiment of the calibration method is similar to the first calibration method explained above with reference to FIGS. 2, 7 and 12 and is performed here in the second calculation sub-unit 50b2.

In the same way as the first calibration method, a reference object 3 (of known size, distance, position and reflection properties) is placed in the field of view of the beam forming arrangement. The expected phase (and received power) differences between the different channels (due to the reference object) are then computed for several (preferably each) frequencies. These results are stored in a storage unit 53 the calibration calculation sub-unit 50b2, and these coefficients shall be called ‘expected external loop differences’, which can be mathematically represented as

E_{Ext loop,x1}(k) (7)

which represents the expected phase difference for this external loop 200 between channel x and channel 1, for frequency step k.

The position of the switches in FIG. 3 are then changed so that the transmitter front ends 14b connect to the transmitter antennas 15 and the receiver front ends 24b connect to the receiver antennas 25. Each transmitter then sends one (or multiple chirp pulses) in turn to the reference object and each receiver passes the received beat frequency samples to the calibration calculation unit 50.

The calibration calculation unit 50 then measures in the measurement unit 51 the phase and amplitude (using the I/Q samples from the different received streams 28-1, 28-2, 28-m) for several (preferably each) sample (which corresponds to several, preferably each, frequency step) for each channel. This measurement may be done over multiple chirp durations (with averaging) to reduce the effects of noise. Additionally, the background can be eliminated by subtracting a measurement performed in the same environment without the calibration target in order to reduce the noise floor. Subsequently, extra filtering may also be used for this step to further reduce the noise floor.

The differences between the channels in terms of measured phase at each frequency step are then calculated in calculation unit 52. This can be mathematically represented as

θ_{Ext,x}(k)−θ_{Ext,1}(k) (8)

which represents the measured external phase differences between channel x and channel 1, for frequency step k (which corresponds to time sample k).

The results of this calculation are passed to further calculations in the calibration calculation sub-unit 50b2. The first calculation takes these calculated difference results between the channels and subtracts the ‘expected external loop differences’ for each frequency step in a first subtraction unit 54. The results of this subtraction for each frequency step and for each channel are then the complex (final) calibration coefficients 35 which are fed to the beam forming unit 30 for normal imaging operation. In this way, the beam forming can take into account the difference channel phase responses at each frequency step. This can mathematically be represented as finalₓ₁(k)

finalₓ₁(k)=(θ_{Ext,x}(k)−θ_{Ext,1}(k))−E_{Ext loop,x1}(k) (9)

which represents the final complex calibration coefficient (here as phase shift) for channel x (referenced to channel 1) for frequency step k (=time step k).

The second calculation in a second subtraction unit 55 takes the final complex calibration coefficients (obtained by the first subtraction unit 54; see equation 9) and subtracts the ‘Step 1 calibration coefficients’ (stored in the storage unit 65) for each frequency step. The results of this subtraction for each frequency step and for each channel are the transmitter and the receiver antenna calibration contribution to the differences between the channels and can be mathematically expressed as Ant.contₓ₁(k)

Ant.contₓ₁(k)=finalₓ₁(k)−Step1ₓ₁(k) (10)

which represents the antenna contribution for channel x (referenced to channel 1) for frequency step k (=time step k).

These values should be relatively time invariant (since they only contain passive components) and are stored in another storage unit 56, e.g. within the calibration calculation sub-unit 50b2. These stored values are used in the update procedure of the algorithm as explained in the following.

Also in this embodiment a control unit 60 is provided that controls said transmitter arrangement 10b to transmit radiation through said internal calibration loop 300 directly to said receiver arrangement 20b and that controls said receiver arrangement 20b to receive radiation through said internal calibration loop 300 transmitted by said transmitter arrangement 10b through said internal calibration loop 300, to generate receive signals and to provide said receive signals to said calibration calculation unit 50. Further, also in this embodiment the control unit 40 is configured to control said transmitter arrangement 10b to transmit radiation of a repetitive waveform (using the waveform generator) changing the frequency with time, in particular by transmitting one or more chirp pulses both for determining the internal and the external calibration coefficients.

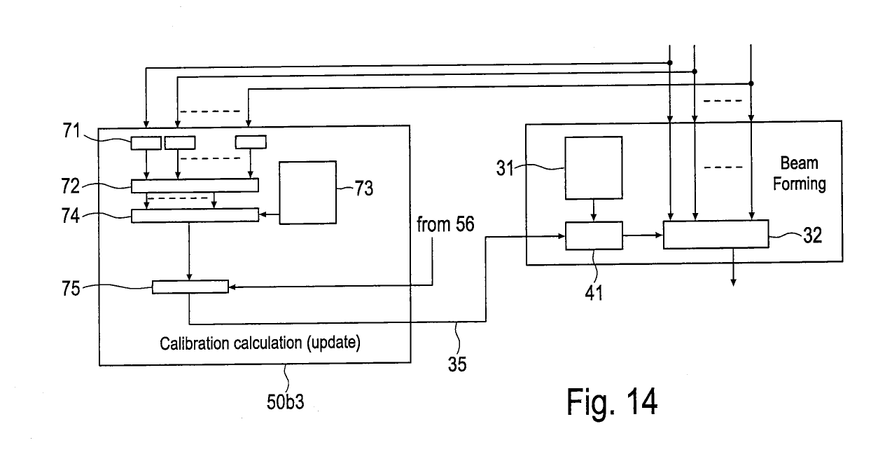

Preferably, in an embodiment, at regular intervals in time (e.g. determined by an internal update timer), in response to another pre-set criterion or in response to a user instruction, normal imaging is paused and the internal selection means are set so that the internal calibration loop 300 is connected and the transmitting and receiving antennas 15, 25 are bypassed. The switches 90, 91b shown in FIG. 3 are correctly set for this update procedure. The steps S12 to S15 of a particular embodiment of this update procedure are shown in FIG. 8 and are illustrated in FIG. 14 showing an embodiment of a calibration calculation sub-unit 50b3 that can be used in addition to sub-units 50b1 and 50b2 shown in FIG. 13 in case the update procedure shall be implemented. Generally, this update procedure is initiated and/or performed under control of the control unit 60.

Each transmit unit 11b, 12b (or 11c, 12c) then sends one (or multiple chirp pulses) through the internal loop 300 and each receiver element 21b, 22b, 23b (or 21c, 22c, 23c) passes the received beat frequency samples to the calibration calculation unit 50. Measurement units 71 of the calibration calculation sub-unit 50b3 measures the phase (using the I/Q samples) for several (preferably each) samples (which corresponds to several, preferably each frequencies) and for each channel. This measurement may be done over multiple chirp durations (with averaging) to reduce the effects of noise. Additionally, also in this update procedure extra filtering may be used by use of a filter unit for this step to reduce the noise floor.

The differences between the channels in terms of measured phase at each frequency step are then calculated in a calculation unit 72 and this can be mathematically expressed as

θₓ(k)−θ₁(k) (11)

which represents the measured phase differences between channel x and channel 1, for frequency step k (which corresponds to time sample k).

From these calculated differences between the channels the pre-stored ‘expected internal loop differences’ (E_{Int loop,x1}(k)) (stored in separate storage unit 73 or, preferably, received from storage unit 63; see FIG. 13) between the channels for each frequency step are subtracted in a subtraction unit 74). The results of this subtraction for each frequency step and for each channel are then the complex updated step 1 calibration coefficients (Step1ₓ₁(k)), which may be stored, e.g. in a separate storage unit (not shown) the calibration calculation sub-unit 50b3:

Step1ₓ₁(k)=(θₓ(k)−θ₁(k))−E_{Int,loop,x1}(k). (12)

These complex coefficients represent an updated version of the differences between the channels without the transmitter and receiver antennas (and their respective feeding networks) which were initially calculated at a previous period of time in equation (6) (in the step 1 explanation).

The final calibration coefficients are then calculated by summing the updated step 1 calibration coefficient (Step1ₓ₁(k)) with the pre-stored (in storage unit 56; see FIG. 13) transmitter and receiver antenna calibration contribution (Ant. contₓ₁(k)) in a summation unit 75. The results of this addition for each frequency step and for each channel are then the complex calibration coefficients 35 which are fed to the beam forming unit 30 for normal imaging operation. In this way, the beam forming can take into account the difference channel amplitude and phase response at each frequency step. This can be mathematically expressed as

finalₓ₁(k)=(Step1ₓ₁(k))+Ant. contₓ₁(k) (13)

To track any anticipated changes of the active components for the different channels, this update step should be performed at regular intervals. Exactly how often this update step needs to be conducted depends upon the implementation and the anticipated environments in which the beam forming device will be used.

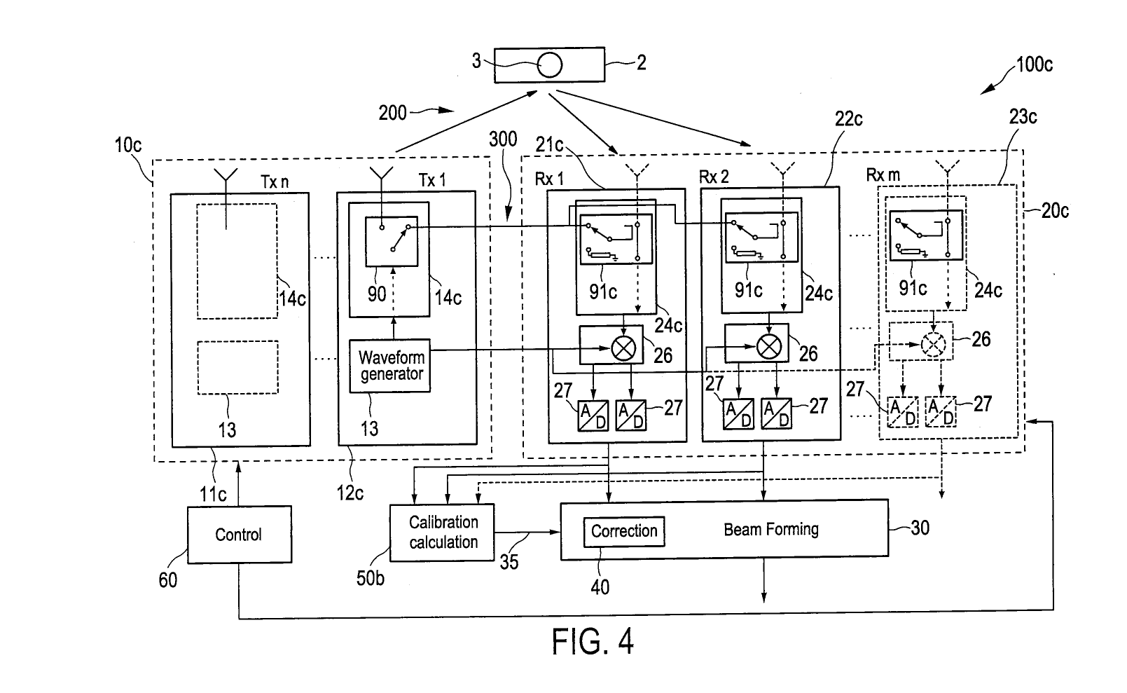

FIG. 4 shows a third embodiment of a beam forming device 100c according to the present disclosure which is to a large extent similar or identical to the second embodiment of the beam forming device 100c shown in FIG. 3, i.e. also comprises a transmitter arrangement 10c including several transmit units 11c, 12c and a receiver arrangement 20c including several receiver elements 21c, 22c, 23c. The transmitter front ends 14c are also generally identical to the transmitter front ends 14b, but the receiver front ends 24c are different from the receiver front ends 24b. In particular, the receiver front ends 24c comprise couplers 91c rather than switches 91b for receiving the radiation (transmit signals) transmitted by the transmit units 11c, 12c via the internal calibration loop 300. Such couplers are preferably used to avoid any signal losses caused by the use of switches in the receiver chain which would increase the receiver noise figure.

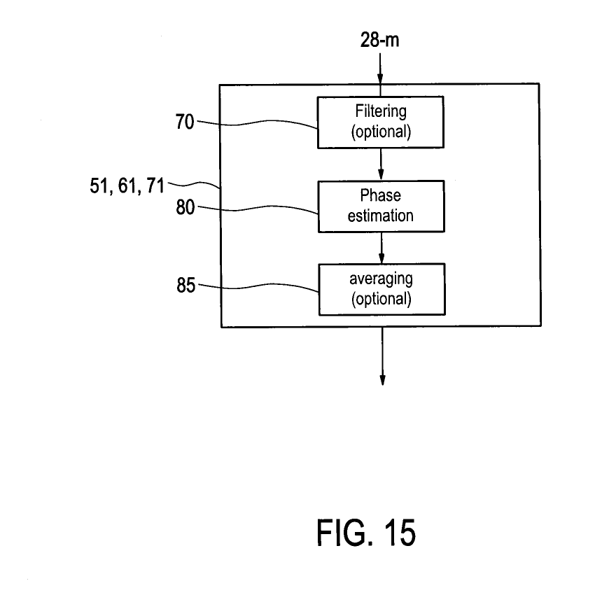

FIG. 15 shows an embodiment of the measurement units 51, 61, 71 as used in the embodiments of the calibration units shown in FIGS. 12 to 14. According to this embodiment the measurement units 51, 61, 71 comprise a optional filter unit 70, a phase estimation unit 80 and an optional averaging unit 85. The same measurement units may be re-used at different times in the calibration time sequence or may be implemented as identical measurement units.

The filter unit 70 filters noise out of the receive signals provided by the receiver elements 21c, 22c, 23c, in particular by band-pass filtering which is important in case of measurement to the reference object. The phase estimation unit 80 estimates or calculates, as explained above, the amplitude and/or phase of the separate channels of said external calibration loop 200 and/or said internal calibration loop 300. The averaging unit 85 averages the estimated amplitude and/or phase differences.

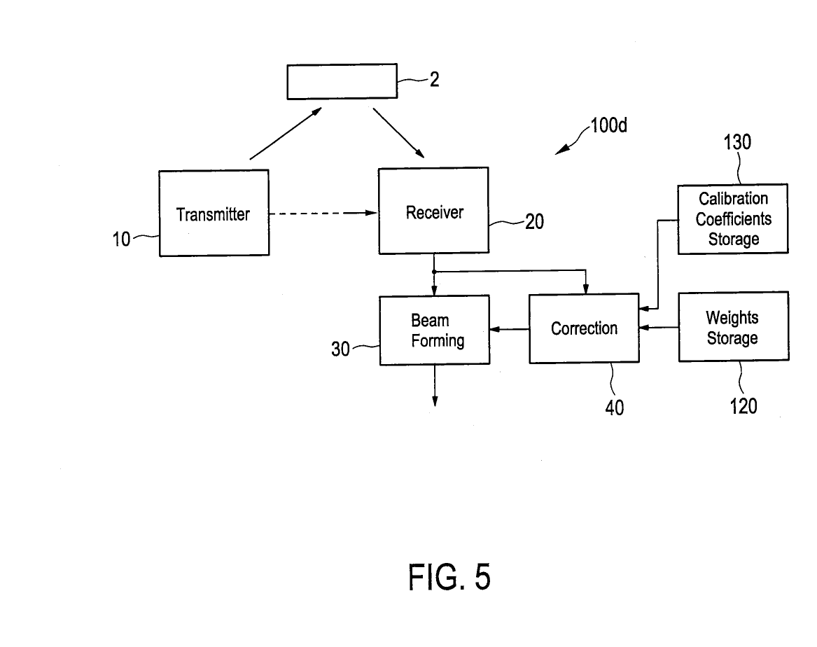

FIG. 5 shows still another embodiment of a beam forming device 100d according to the present disclosure. In this embodiment the frequency-dependent calibration coefficients used for correction of the preliminary beam forming weights are previously acquired and stored in a calibration coefficient storage unit 130. The preliminary beam forming weights are preferably stored a weights storage unit 120. Alternatively, the preliminary beam forming weights may be calculated on the fly. Both storage units 120 and 130 might be the same physical unit, e.g. a hard disk of a computer or a semiconductor memory, or might be separate physical units. Further, also the corrected beam forming weights might be stored in the weights storage unit 120, and both storage units may also be part of the beam forming unit 30.

Since embodiments of beam forming devices according to the present disclosure could use the FMCW technique, the FMCW technique shall be briefly described. A thorough explanation of FMCW can be found in G. Brooker, “Understanding Millimeter Wave FMCW Radars”, 1st International Conference on Sensing Technology, Nov. 21-23, 2005, Palmerston North, New Zealand, p. 152-157.

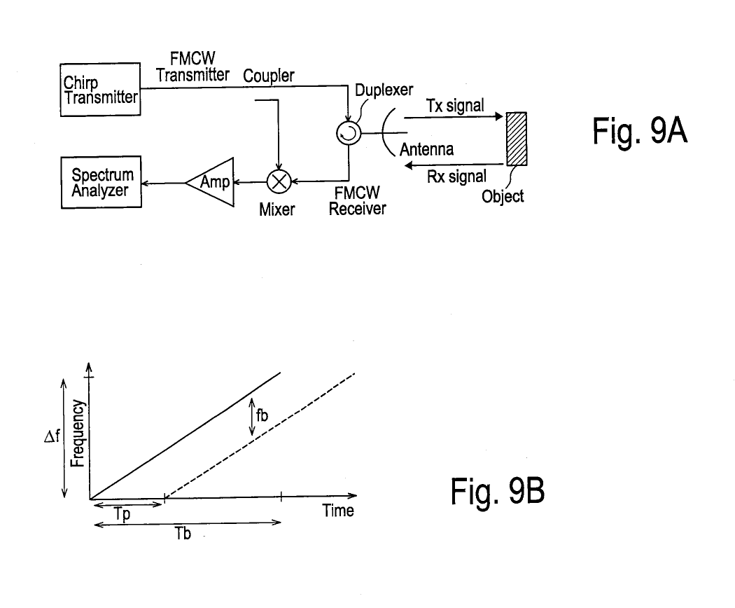

A FMCW radar, as generally shown in FIG. 9A, transmits a continuous wave signal that is frequency modulated (frequency is changing with time) to produce a chirp signal. This is transmitted to the object to be examined and is also fed to the receiver via a coupler. The transmitted signal will be reflected by the object, wherein the level of the reflection will depend upon the properties of the object, and be received by the receiver section of the FMCW radar. Since the transmitted chirp pulse (having a chirp pulse duration T_{b}) is changing its frequency with time, the exact frequency received for a given time instant depends upon how far away the object is located and upon the corresponding flight time (indicated as Tp in FIG. 9B). This received signal is then mixed with the transmitted chirp (via the coupler) and the output of the mixer has a frequency which is the difference in frequency between the transmitted and received signal. This is known as the beat frequency (f_{b}) and is directly proportional to the distance between the FMCW radar and the object.

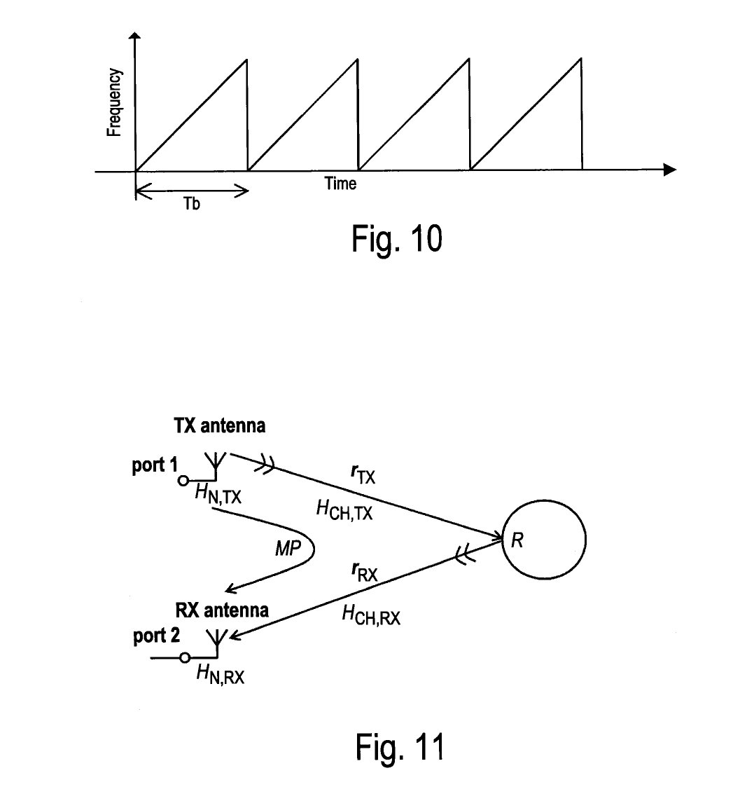

The frequency variation against time of the transmitter signal (chirp pulse) and the received signal are shown in FIG. 9B as solid and dotted lines respectively. The difference in frequency between the transmitted signal and the received signal, the beat frequency (f_{b}) is also labelled. A typical FMCW radar system would typically send chirp pulses continuously and a typical variation of frequency with time is shown in FIG. 10. Other variations of the ramp signals are also possible.

In the following possible ways to obtain E_{Ext loop,x1}(k), as particularly mentioned in equations (1) and (7), shall be explained in more detail. The value E_{Ext loop,x1}(k) which is the expected external phase difference between channel x and channel 1 for frequency step k can generally either be obtained via a simulation or via measurements.

For simulation the physical location of the transmitter and receiver for each channel and the associated propagation path (from transmitter (=transmit unit) and receiver (=receiver element)) for each channel are calculated. Additionally, the transmission path is simulated or calculated, for example using a ray tracing approach. Optionally, the reflection properties of the reference object can be simulated or calculated. These simulations or calculations are preferably done for each channel x and each frequency step k.

If the value of E_{Ext loop,x1}(k) is to be obtained via measurements the example arrangement shown in FIG. 11 could be used for each channel (transmitter/receiver antenna pair). The measured transfer response (S_{21, measure}) between port 1 and port 2 would typically be measured using a calibrated network signal analyser for all of the frequency steps k required. By referring to the this channel as channel 1, and denoting this response as S_{21,measure,1} this response can be expressed as

$${S}_{21 , measure , 1} = j ω \frac{4 π}{{λ}^{2}} {R}_{1} {H}_{CH , TX , 1} {H}_{CH , RX , 1} {H}_{N , TX , 1} {H}_{N , RX , 1} + {MP}_{1}$$

which is composed of the following components:
TX antenna characteristic for channel 1 H_{N,TX,1}
RX antenna characteristic for channel 1 H_{N,RX,1}
TX free space propagation for channel 1

$${H}_{CH , TX , 1} = \frac{c}{2 ω {r}_{{TX}_{1}}} {e}^{- jω \frac{{r}_{TX}}{c}} = \frac{λ}{4 π {r}_{{TX}_{1}}} {e}^{- jω \frac{{r}_{TX}}{c}}$$

$${H}_{CH , RX , 1} = \frac{c}{2 ω {r}_{{RX}_{1}}} {e}^{- jω \frac{{r}_{RX}}{c}} = \frac{λ}{4 π {r}_{{RX}_{1}}} {e}^{- jω \frac{{r}_{RX}}{c}}$$

RX free space propagation for channel 1
Reflectivity of the target for channel 1 R₁
MP₁ which includes unwanted multipath component (including leakage and mutual coupling) for channel 1.

To determine the value of MP₁, measurements would then be made for this channel with the reference object removed:

S_{21,MP,1}=MP₁

The channel response for the channel 1 can then be calculated by

$$\begin{matrix}{S}_{21 , 1} = jω \frac{4 π}{{λ}^{2}} {R}_{1} {H}_{CH , TX , 1} {H}_{CH , RX , 1} {H}_{N , TX , 1} {H}_{N , RX , 1} \\ = {S}_{21 , measure , 1} - {S}_{21 , MP , 1}\end{matrix}$$

Optionally, the channel response S_{21,1} can be band-pass filtered, being the band centered at the peak of the reference object. This is done to eliminate the interaction between the reference object and the background, for example double reflections. To determine the value of the E_{Ext loop,x1}(k) only the external response from the transmitter antenna to the reference object and then to the receiver antenna are of interest. Once the transmitter and receiver antenna characteristics (H_{N,TX,1},H_{N,RX,1}) are known, the external response (S_{21,external,1}) for channel 1 can then be calculated as

$${S}_{21 , external , 1} = \frac{{S}_{21 , \cdot 1}}{( {H}_{N , TX , 1} \cdot {H}_{N , RX , 1} )} .$$

This measurement and calculation procedure is then performed for each channel (Tx/Rx antenna pair) in the MIMO beam forming arrangement. Each of the different channels are located in different physical positions with respect to the reference object. Since these measurements and calculations are performed for each frequency step k, the external response for a given channel x at frequency step k can be represented as

$${S}_{21 , external , x} ( k ) = \frac{{S}_{21 , \cdot x} ( k )}{( {H}_{N , TX , x} ( k ) \cdot {H}_{N , RX , x} ( k ) )} .$$

The expected external phase difference between channel x and channel 1 E_{Ext,loop,x1}(k) can then be expressed as

E_{Ext loop,x1}(k)=∠(S_{21,external,x}(k))−∠(S_{21,external,1}(k))

where the operation ∠(.) extracts the angle.

Even further, in a preferred embodiment, transmit units are designed as illumination units that are configured to illuminate a scene.

From various results of application of the proposed method with and without low-pass filtering of the calibration coefficients and/or band-pass filtering of the measurement to the reference object it can be observed ho the band pass filtering of the measurement to the reference increases the peak to side lobe level and the low pass filtering of the calibration coefficients further increases the peak to side lobe level. Further, it has been observed how no beam focusing is obtained if the measured data is not calibrated as proposed, while beam focusing is obtained if the proposed method is applied.

As explained above the control unit controls said transmitter arrangement to transmit radiation towards said scene covering at least said at least two separate frequencies, while a reference object is placed in the scene at a known distance from the at least one transmit antenna and the at least one receive antenna. Further, the control unit controls said receiver arrangement to receive radiation at said at least two separate frequencies from said reference object, to generate receive signals and to provide said receive signals to said calibration calculation unit.

The estimation of the distance to the calibration target can be done by means of an external device, or preferably it can be done internally by using the radar functionality of the system. This second option can be done using at least two measurements from channels with high coupling components. The distance to the target from these two channels is obtained by applying peak detection to both the coupling and the target peak. The positions of these two detected peaks are subtracted and triangulation is applied taking into account the known distance between the channels, based on the antenna configuration of the system.

The closer the distance of the target used for calibration, the higher accuracy is needed to obtain a good calibration. In case of calibration at short distance, positioning algorithms with high accuracy are needed (for example superresolution) to obtain a high quality calibration. When the distance to the target increases, the positioning accuracy requirements are reduced.

In an embodiment the beam forming device further comprises selection elements, in particular switching elements or coupler, that select between external calibration loop and internal calibration loop for obtaining said external calibration coefficients or said internal calibration coefficients.

In an embodiment said selection elements comprise an transmit switching element for switching between the transmission of a transmit signal through said external calibration loop and the transmission of a transmit signal through said internal calibration loop and a receive switching element for switching between the reception of radiation from the scene trough said external calibration loop in response to the transmission of a transmit signal transmitted by a transmit antenna through said external calibration loop and the reception of a transmit signal through said internal calibration loop transmitted by a transmit antenna through said internal calibration loop.

In an embodiment the beam forming device further comprises an estimation unit that calculates or estimates the amplitude and/or phase of said separate channels of said external calibration loop or of said internal calibration loop.

In an embodiment said calibration calculation unit is configured to calculate said internal calibration coefficients from complex samples, in particular complex samples including an in-phase channel sample portion and a quadrature channel sample portion, of said receive signals at a plurality of separate frequencies

In an embodiment said control unit is configured to control said transmitter arrangement to transmit signals of a repetitive waveform changing the frequency with time, in particular by transmitting one or more chirp pulses.

In an embodiment said calibration calculation unit is configured to calculate said internal calibration coefficients from receive signals obtained over multiple chirp pulse durations used by said transmitter arrangement to transmit radiation towards said reference object.

Preferably, said beam forming device is configured for MIMO beam forming or MIMO backprojection.

In an embodiment the beam forming device comprises at least two transmit antennas that are configured to sequentially transmit radiation towards said scene.

In another embodiment the beam forming device comprises at least two transmit antennas that are configured to simultaneously transmit radiation towards said scene, wherein the radiation transmitted by different transmit antennas is coded or modulated differently or is transmitted at different frequencies.

In summary, the present disclosure provides a beam forming device and method providing optimum beam forming performance and, hence, high imaging spatial resolution, particularly for wideband beam forming. Further, an appropriately adapted beam forming device and method are proposed. The disclosure is based on a novel efficient calibration scheme which takes into account that the different channels may have different phase and amplitude responses, and that these different responses need to be known so that the correct complex weights for beam forming can be calculated. Additionally, for wideband systems the phase and amplitude responses of the different channels may be different at different frequencies and these differences need to be taken into account. Furthermore, the individual phases and amplitudes of the different channels may change with time (due to component ageing, vibration or changes in temperature, pressure and/or humidity). In addition to a full wideband calibration scheme that calibrates the whole receiver and transmitter chain for each channel, an internal calibration scheme which can be performed at regular intervals to track any phase or amplitude changes of the active components in each channel with may occur with time.

Obviously, numerous modifications and variations of the present disclosure are possible in light of the above teachings. It is therefore to be understood that within the scope of the appended claims, the invention may be practiced otherwise than as specifically described herein.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

In so far as embodiments of the invention have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present invention. Further, such a software may also be distributed in other forms, such as via the Internet or other wired or wireless telecommunication systems.

1. A beam forming device comprising:
a transmitter arrangement comprising at least one transmit antenna that transmits radiation towards a scene,
a receiver arrangement comprising at least one receive antenna that receives radiation from said scene and at least one receive unit that generates receive signals from said received radiation, wherein the total number of transmit antennas and receive antennas is at least three,
a beam forming unit that performs beam forming to obtain beam formed output signals from said receive signals by use of corrected beam forming weights, and
a correction unit that corrects preliminary beam forming weights in amplitude and/or phase by use of frequency-dependent final calibration coefficients representing the different amplitude and/or phase responses of the different channels between said at least one transmit antenna and said at least one receive antenna at two or more separate frequencies covered by the radiation used for illumination of the scene.

2. The beam forming device as claimed in claim 1,
further comprising only an external calibration loop, wherein the final calibration coefficients correspond to external calibration coefficients obtained through said external calibration loop.

3. The beam forming device as claimed in claim 1,
further comprising an external calibration loop and an internal calibration loop, wherein the final calibration coefficients are calculated from external calibration coefficients obtained through said external calibration loop and internal calibration coefficients obtained through said internal calibration loop.

4. The beam forming device as claimed in claim 2,
further comprising a calibration calculation unit that calculates said external calibration coefficients from measured amplitude and/or phase differences between different channels of said external calibration loop and calculated or estimated amplitude and/or phase differences between different channels of said external calibration loop.

5. The beam forming device as claimed in claim 4,
wherein said calibration calculation unit is configured to calculate said external calibration coefficients by subtracting said calculated or estimated amplitude and/or phase differences between different channels from measured amplitude and/or phase differences between different channels.

6. The beam forming device as claimed in claim 4,
further comprising a control unit that controls said transmitter arrangement to transmit radiation towards said scene covering at least said at least two separate frequencies, while a reference object is placed in the scene at a known distance from the at least one transmit antenna and the at least one receive antenna, and that controls said receiver arrangement to receive radiation at said at least two separate frequencies from said reference object, to generate receive signals and to provide said receive signals to said calibration calculation unit.

7. The beam forming device as claimed in claim 6,
wherein said calibration calculation unit is configured to calculate said external calibration coefficients from complex samples, in particular complex samples including an in-phase channel sample portion and a quadrature channel sample portion, of said receive signals at a plurality of separate frequencies.

8. The beam forming device as claimed in claim 6,
wherein said control unit is configured to control said transmitter arrangement to transmit radiation towards said scene by transmitting transmit signals of a repetitive waveform changing the frequency with time, in particular by transmitting one or more chirp pulses.

9. The beam forming device as claimed in claim 6,
wherein said calibration calculation unit is configured to calculate said external calibration coefficients from receive signals obtained over multiple chirp pulse durations used by said transmitter arrangement to transmit radiation towards said reference object.

10. The beam forming device as claimed in claim 9,
further comprising a filter unit that filters noise out of said receive signals and/or said external calibration coefficients.

11. The beam forming device as claimed in claim 3,
further comprising a calibration calculation unit that calculates said internal calibration coefficients from measured amplitude and/or phase differences between different channels of said internal calibration loop and calculated, estimated or measured amplitude and/or phase differences between different channels of said internal calibration loop.

12. The beam forming device as claimed in claim 11,
wherein said calibration calculation unit is configured to calculate said internal calibration coefficients by subtracting said calculated, estimated or measured amplitude and/or phase differences between different channels from measured amplitude and/or phase differences between different channels.

13. The beam forming device as claimed in claim 11,
further comprising a control unit that controls said transmitter arrangement to transmit transmit signals through said internal calibration loop directly to said receiver arrangement, said transmit signals covering at least said at least two separate frequencies, and that controls said receiver arrangement to receive a transmit signal through said internal calibration loop transmitted by said transmitter arrangement through said internal calibration loop, to generate receive signals and to provide said receive signals to said calibration calculation unit.

14. The beam forming device as claimed in claim 13,
wherein said control unit is configured to initiate an update of said internal calibration coefficients by use of updated internal calibration coefficients, in particular by adding the updated internal calibration to a pre-calculated antenna contribution weight to derive the final calibration coefficients, based upon a predetermined update criterion or based upon a corresponding user instruction.

15. The beam forming device as claimed in claim 14,
wherein said control unit is configured to initiate the update of said internal calibration coefficients at regular intervals in time or after a predetermined number of beam forming operations of the beam forming device.

16. The beam forming device as claimed in claim 1,
wherein said correction unit is configured to correct said preliminary beam forming weights for all different channel and at a plurality frequencies by use of frequency-dependent final calibration coefficients, wherein for each different channel a final calibration coefficient is used for each of a plurality of frequencies covered by the radiation transmitted towards the scene.

17. A beam forming method comprising the steps of:
transmitting radiation towards a scene by at least one transmit antenna,
receiving radiation from said scene by at least one receive antenna, wherein the total number of transmit antennas and receive antennas is at least three,
generating receive signals from said received radiation,
correcting preliminary beam forming weights in amplitude and/or phase by use of frequency-dependent final calibration coefficients representing the different amplitude and/or phase responses of the different channels between said at least one transmit antenna and said at least one receive antenna at two or more separate frequencies covered by the radiation transmitted towards the scene, and
beam forming to obtain beam formed output signals from said receive signals by use of the corrected beam forming weights.

18. An active imaging device for imaging a scene, comprising:
a beam forming device as claimed in claim 1, and
a processing unit for processing said beam formed output signals.

19. An active imaging method for imaging a scene comprising the steps of:
a beam forming method as defined in claim 17, and
processing said beam formed output signals.

20. A computer readable non-transitory medium having instructions stored thereon which, when carried out on a computer, cause the computer to perform the steps of the method as claimed in claim 17.
